(19) United States
(12) Patent Application Publication
(10) Pub. No.: US 2020/0063796 A1
(43) Pub. Date: Feb. 27, 2020

(54) Steering System

(71) Applicant: Robert Bosch GmbH, Stuttgart (DE)

(72) Inventors: Jens-Uwe Hafermalz, Waeschenbeuren (DE); Dennis Fuechsel, Schwaebisch Gmünd (DE)

(21) Appl. No.: 16/462,809

(22) PCT Filed: Oct. 6, 2017
(86) PCT No.: PCT/EP2017/075503

§ 371 Date: May 21, 2019

(30) Foreign Application Priority Data
Nov. 21, 2016 (DE) 10 2016 122 378.6

(51) Int. Cl. F16C 32/06; F16C 27/04; B62D 5/04

(52) U.S. Cl. CPC F16C 32/0688; B62D 5/0463; F16C 27/04

(57) ABSTRACT

A steering system for a motor vehicle includes a steering gear and a steering motor. The steering gear includes a housing, gear, screw pinion shaft, fixed bearing, and floating bearing. The fixed bearing has a rotational bearing received in a sleeve, and a pivot ring with inner and outer rings pivotably connected by at least one torsion web. The shaft has a screw pinion meshed with the gear and a portion to one side of the pinion mounted in the rotational bearing. The inner pivot ring is integrated into or connected to the sleeve, and the outer ring is fixed to the housing. The floating bearing is positioned on the other side of the screw pinion, has a further rotational bearing rotatably received in a bushing mounted in the housing, and mounts the other side portion of the shaft. The motor is drivingly connected to the shaft via a coupling element. At least one of (i) one or more of the outer ring and the bushing is fixed to the housing solely via a vibration-damping decoupling element, and (ii) one or more of the pivot ring, the bushing, the pinion, the gear and the coupling element are at least partially made from a vibration-damping material. A vibration excitation, and thus a sound emission of the housing due to vibrations produced from rotation of the shaft and the gear, is kept as low as possible, thereby having a positive effect on the noise behavior of the steering system during operation.

The invention relates to a steering system, in particular a power steering system, for a motor vehicle.

In most motor vehicles, there are installed power steering systems which, during steering maneuvers, generate an assisting torque and thereby reduce the steering moment that has to be imparted to the steering column by the driver.

The known power steering systems are based on a steering gear which converts the drive power of a hydraulic or electric steering motor and transmits this to, for example, the steering column. Such steering gears may be designed in the form of a helical rolling-contact gear and in particular as a helical-wheel gear or worm gear. These then comprise a toothed wheel, which may be connected directly or indirectly to the steering column, and a pinion which meshes with said toothed wheel and which is driven by the steering motor via a shaft.

What has been found to be a problem in the case of such steering gears is gear play which arises owing to component tolerances, different thermal expansions of the gear elements and/or owing to wear. In particular during so-called alternating steering, that is to say during directly successive steering maneuvers with an alternating steer angle direction, such gear play generates undesired noises, which result from the alternating abutment of opposite flanks of the teeth of pinion and toothed wheel.

It is known for such gear play to be eliminated as far as possible by virtue of the pinion shaft being mounted so as to be pivotable about an axis running perpendicular to the longitudinal axis of the pinion shaft and at a distance from the toothing engagement of pinion and toothed wheel, and being pressed against the toothed wheel by means of one or more spring elements. The pivotability of the pinion shaft is in this case generally integrated into one of the two bearing arrangements by means of which the pinion shaft is mounted at the ends. This bearing arrangement is referred to as “fixed bearing”. The bearing arrangement in the region of the other end is then designed with a defined play (so-called “floating bearing”; cf. for example DE 10 2005 035 020 A1) in order to permit the deflection caused by the pivoting movement. The fixed bearing is generally provided at the drive side, whereas the floating bearing is provided at the free end of the pinion shaft. The one or more spring elements for pressing the pinion against the toothed wheel may in this case be integrated both into the floating bearing and into the fixed bearing.

A steering gear of said type, in which the spring force for the spring loading is generated by means of the fixed bearing, is known for example from DE 10 2009 054 655 A1. In the case of this steering gear, provision is made for the rolling bearing, which receives the pinion shaft in the region of the fixed bearing, to be mounted at the outside in a pivot sleeve. The pivot sleeve comprises a bearing sleeve, which receives the rolling bearing substantially without play, and an outer ring, which is held substantially without play in a receptacle of a housing of the steering gear, wherein the outer ring and the bearing sleeve are connected by means of multiple torsion webs which are twisted in the event of the outer ring rotating relative to the bearing sleeve. After the assembly of the steering gear, the torsion webs are twisted such that the elastic restoring action thereby generated effects the spring loading of the pinion shaft.

A complete elimination of gear play is not always possible even by means of spring-loading of a pinion shaft of a steering gear as per DE 10 2009 054 655 A1, resulting in generation of noise, caused by said gearing play, during the operation of the steering gear. In addition to this there is the relatively high transmission ratio regularly provided in the case of the transmission of the drive power from the pinion to the toothed wheel. Such a steering gear is specifically generally configured for relatively high rotational speeds of the steering motor and thus of the pinion and of the pinion shaft that comprises the pinion, wherein such relatively high rotational speeds are associated with correspondingly high local speeds in the toothing engagement and in the rotary bearings that serve for the mounting of the pinion shaft, and consequently with correspondingly intense generation of noise.

The invention is based on the object of improving a steering system such as is known from DE 10 2009 054 655 A1 with regard to the generation of noise during operation.

Said object is achieved by a steering system as claimed in patent claim 1. Advantageous embodiments of the steering system according to the invention are the subjects of the dependent patent claims and/or emerge from the following description of the invention.

The invention is based on the concept of keeping the generation of noise in a generic steering system during operation as low as possible not by primarily or exclusively attempting to eliminate the causes of the generation of noise but by limiting a propagation of vibrations that cause the noises within the steering system in as advantageous a manner as possible. Here, this concept is based on the realization that a primary cause of perceptible generation of noise in a generic steering system is sound radiation via the housing, and that such perceptible generation of noise can be reduced in an effective and simultaneously structurally relatively simple manner if the housing is as far as possible decoupled from vibrations that would cause corresponding sound radiation.

Accordingly, a steering system for a motor vehicle is provided, which comprises a steering gear, wherein the steering gear has a housing, a toothed wheel, a helical pinion, which meshes with the toothed wheel, and a helical pinion shaft which comprises the helical pinion.

The helical pinion shaft is mounted on one side of the helical pinion in a fixed bearing, which comprises a rotary bearing in which the pinion shaft is received. For this purpose, the rotary bearing may comprise at least one inner bearing ring, one outer bearing ring and possibly, in the case of a preferred embodiment as a rolling bearing and in particular as a ball bearing, multiple rolling elements, in particular balls, arranged between the bearing rings, wherein the pinion shaft is received within the inner bearing ring of the rotary bearing. The rotary bearing and in particular an outer bearing ring of the rotary bearing of the fixed bearing is furthermore received in a bearing sleeve. Furthermore, the fixed bearing comprises a pivot ring which has an outer ring and an inner ring which are pivotably connected to one another by means of one or more torsion webs, wherein the inner ring is connected to or is an integral constituent part of the bearing sleeve, and the outer ring is arranged fixedly (with regard to at least one direction, preferably with regard to all directions, that is to say immovably) in the housing of the steering gear.

Furthermore, the helical pinion shaft of a steering system according to the invention is mounted on the other side of the helical pinion in a floating bearing which comprises a rotary bearing in which the pinion shaft is received and which is received in a bearing bushing which is mounted in the housing, wherein the bearing bushing ensures radial mobility of the rotary bearing within the housing. The floating bearing may for example have an embodiment as per DE 10 2005 035 020 A1. In particular, provision may be made for the bearing bushing of the floating bearing to have an inner bushing, which receives the rotary bearing, and an outer bushing, which surrounds the inner bushing and which is arranged fixedly in the housing, wherein the outer bushing and the inner bushing delimit an annular gap, and wherein the outer bushing and the inner bushing are connected to one another by means of a flexible connecting portion such that said outer bushing and inner bushing are movable relative to one another in at least one radial direction.

A steering system according to the invention furthermore comprises a steering motor which is connected, exclusively via a clutch element, with rotational driving action to the helical pinion shaft of the steering gear, which steering motor may in particular be in the form of an electric motor.

Such a steering system is, in accordance with the underlying concept of the invention, characterized in that the outer ring of the pivot ring of the fixed bearing and/or the bearing bushing is arranged fixedly, (in each case) exclusively (that is to say without direct contact with the housing) with the interposition of a vibration-damping decoupling element, in the housing (1). Here, provision may preferably be made for the vibration-damping decoupling element(s) to be formed at least partially, preferably entirely, from a (at least one) vibration-damping material, preferably a plastic, in particular a thermoplastic material, or an elastomer (for example a rubber). Alternatively or in addition, it is also possible for such an element to be formed with a vibration-damping functionality by structural measures.

Alternatively or in addition, in a steering system according to the invention, provision is made for the pivot ring of the fixed bearing, the bearing bushing of the floating bearing, the helical pinion, the toothed wheel and/or the clutch element to be formed at least partially from a (at least one) vibration-damping material. Here, too, provision may preferably be made for the vibration-damping material to be a plastic (thermoplastic material) or an elastomer, wherein it is assumed that any plastic (thermoplastic material) and any elastomer has better vibration-damping characteristics in relation to metals and in particular steel and aluminum alloys, which constitute the conventional materials for forming steering systems of motor vehicles.

The steering system according to the invention may in particular be in the form of a power steering system in the case of which an assisting torque can be generated by means of the steering motor, such that a steering moment that is to be imparted to the steering column, for the purposes of steering the motor vehicle, by a driver of a motor vehicle which comprises the power steering system is reduced (possibly temporarily even to zero). Alternatively, it is also possible for the steering system to be designed such that the entire steering moment required for the purposes of steering is generated (at all times) by the steering motor (in particular for a so-called steer-by-wire functionality of the steering system or of the motor vehicle).

The invention also relates to a motor vehicle having a steering system according to the invention.

The indefinite articles (“a”, “an”, “of a” and “of an”), in particular in the patent claims and in the description that generally discusses the patent claims, are to be understood as such and not as numerals. Components discussed in concrete terms using these are thus to be understood as being present at least singly, and as being capable of being present in a multiplicity.

The invention will be discussed in more detail below on the basis of an exemplary embodiment illustrated in the drawings. In the drawings:

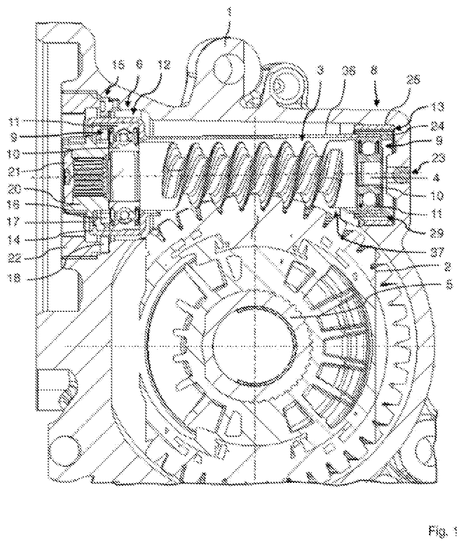

FIG. 1 shows a longitudinal section through a steering gear of a steering system according to the invention;

FIG. 2 shows, in a longitudinal section, a portion of the steering gear as per FIG. 1 and a portion of a steering motor, connected to the steering gear, of a steering system according to the invention;

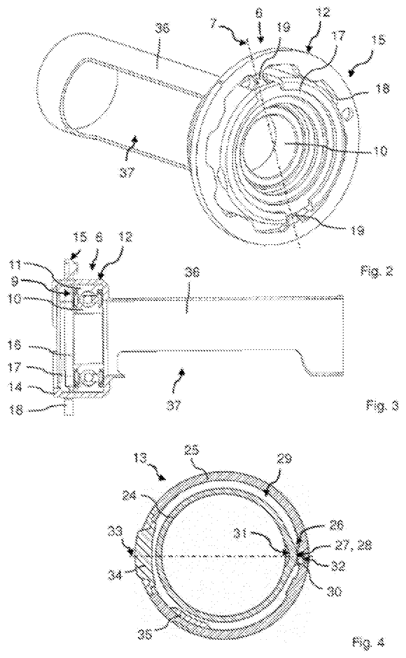

FIG. 3 shows the fixed bearing of the steering gear as per FIG. 1 in a frontal view; and

FIG. 4 shows the bearing bushing of the floating bearing of the steering gear as per FIG. 1 in a cross section.

FIG. 1 shows the main constituent parts of a steering gear of a steering system according to the invention. Said steering gear comprises a housing 1, within which housing there are rotatably arranged a toothed wheel 2 and a helical pinion 3 which meshes with the toothed wheel 2. The helical pinion 3 and a helical pinion shaft 4 which comprises the helical pinion 3 are formed integrally in the form of a worm.

The toothed wheel 2 is fastened fixedly to an output shaft 5 (cf. FIG. 1) of the steering gear. Said output shaft 5, which in the exemplary embodiment shown has a toothing for a secure rotationally conjoint connection to the toothed wheel 2, may for example mesh with a steering rod which is formed at least in one portion as a toothed rack, whereby the toothed rack performs a translational movement which can, in a known manner, be converted by means of wheel steering levers (not illustrated) into a pivoting movement of steerable wheels (not illustrated) of the motor vehicle. The output shaft 5 may however also be a steering column of a power steering system, which steering column is connected to a steering wheel and acts via a steering pinion on the steering rod.

The helical pinion shaft 4 has a drive-side end, by means of which said pinion shaft is connectable or connected to the output shaft 7 of a steering motor 6 (for example an electric motor) (cf. FIG. 2). In the region of said drive-side end, the helical pinion shaft 4 is mounted by means of a first bearing arrangement in the housing 1. This bearing arrangement is formed as a fixed bearing 8, which permits pivoting of the helical pinion shaft 4 about a pivot axis 9 (cf. FIG. 3). This pivoting gives rise to a deflection of that end of the helical pinion shaft 4 which is situated opposite the drive-side end, which pinion shaft is mounted there by means of a floating bearing 10 in a corresponding receptacle of the housing 1. Said floating bearing 10 is designed to permit the deflection of said end that results from the pivoting of the helical pinion shaft 4.

Both the fixed bearing 8 and the floating bearing 10 comprise in each case one rotary bearing in the form of a ball bearing 11, 12. The corresponding portions of the helical pinion shaft 4 are mounted in inner bearing rings of said ball bearings 9, 10, whereas outer bearing rings of the ball bearings 11, 12 are mounted in in each case one bearing device 13, 14, which bearing devices are in turn received in corresponding receptacles of the housing 1. The bearing devices 13, 14 are structurally designed so as to permit, in the case of the fixed bearing 8, the pivoting of the helical pinion shaft 4 about the pivot axis 9 and, in the case of the floating bearing 10, the deflection of the free end of the helical pinion shaft 4.

For this purpose, the bearing device 13 of the fixed bearing 8 comprises a bearing sleeve 15 with circular-ring-shaped cross section, which, at an inner side, in a first longitudinal portion, receives the ball bearing 11 and, in a second longitudinal portion, receives an inner ring 17 of a pivot ring 16. The inner ring 17 of the pivot ring 16 is, with the interposition of a support disk 18, mounted rotationally fixedly and in an axially secured manner within the bearing sleeve 15, wherein the inner ring 17 is supported on the outer bearing ring 19 of the ball bearing 11. The pivot ring 16 comprises not only the inner ring 17 but also an outer ring 20. The outer ring 20 is connected via two torsion webs 21 (cf. FIG. 3) to the inner ring 17. The outer ring 12, the inner ring 17 and the torsion webs 21 are preferably formed as a single piece, for example from spring steel.

The ball bearing 11 is axially secured in position on the helical pinion shaft 4, with the interposition of a thrust piece 22, by means of a screw 23 which is screwed into an internal thread integrated into the drive-side end of the helical pinion shaft 4. The outer ring 20 of the pivot ring 16 is axially secured in position within the housing 1 by means of a screw ring 24 which has an external thread which is screwed into a corresponding internal thread of the housing 1.

The two torsion webs 17 define the position of the pivot axis 9 about which the outer ring 20 is pivotable relative to the inner ring 17. The torsion webs 21 and thus the pivot axis 9 however in this case run not through the center of the pivot ring 16 and thus also not through the center of the cross section of the helical pinion shaft 4 but rather so as to be radially offset in relation thereto (cf. FIG. 3). The pivot axis 9 thus does not intersect the longitudinal axis 25 of the helical pinion shaft 4. Owing to the radial offset of the torsion webs 21 relative to the center of the pivot ring 16, the pivot axis 9 is relocated into the vicinity of the outer circumference of the helical pinion shaft 4, whereby the generation of reaction moments that arise or would arise owing to the toothing forces that are generated during the toothing engagement of helical pinion 3 and toothed wheel 2, in conjunction with the spacing of the line of action of said toothing forces from the pivot axis 9, can be reduced or eliminated. For the most complete possible elimination of the reaction moments, provision is made for the pivot axis 9 to lie within that tangential plane which is formed at the contact point of the two pitch circles or rolling circles of toothed wheel 2 and helical pinion 3.

The torsion webs 21 of the pivot ring 16 not only permit a pivoting of the outer ring 20 relative to the inner ring 17 and thus of the helical pinion shaft 4 relative to the toothed wheel 2 or the housing 1 but simultaneously also impart the spring force by means of which the helical pinion 3 of the helical pinion shaft 4 is forced into the toothing of the toothed wheel 2 in order to realize the least possible gear play and thus correspondingly little generation of noise during the operation of the steering gear, in particular during so-called alternating steering. Said spring force arises from the fact that, during the assembly of the steering gear, the helical pinion shaft 4 is deflected, owing to contact with the toothed wheel 2, to such an extent as to generate sufficient torsion of the torsion webs 21, whereby the elastic restoring moments resulting from the torsion of the torsion webs 21 act counter to said deflection of the helical pinion shaft 4 and thus force the latter against the toothed wheel 2.

The bearing device 14 of the floating bearing 10 is in the form of a bearing bushing 14 which comprises an inner bushing 26 which, in an unloaded neutral position of the bearing bushing 14, is arranged as far as possible concentrically within an outer bushing 27 (cf. FIG. 4). In one portion, the inner bushing 26 is connected by means of a connecting portion 28 to the outer sleeve 27. In the region of the connecting portion 28, the inner bushing 26 and the outer bushing each have, in cross section or radial section (cf. FIG. 4), a projection 29, 30 which runs in curved fashion, which projections project—oppositely—into the annular gap 31 formed between the inner bushing 26 and the outer bushing 27. Here, the tips of the two projections 29, 30 make contact.

In the region of the projections 29, 30, the inner bushing 26 and the outer bushing 27 are surrounded by an elastomer casing 32. Here, the elastomer casing 32 is designed such that it does not project beyond the outer surfaces of the inner bushing 26 and of the outer bushing 27. For this purpose, firstly, the axial length of the inner bushing 26 and of the outer bushing 27 is smaller in the circumferential portions that form the projections 29, 30 than in the other circumferential portions. In this way, depressions (not visible) are formed in which the elastic material of the elastomer casing 32 is received. Furthermore, the inner bushing 26 has, on its inner side, and the outer bushing 27 has, on its outer side, in each case a further depression 33, 34 running in an axial direction, wherein the material of the elastomer casing 32 is likewise received in said depressions 33, 34. In the region of the annular gap 31, too, the projections 29, 30 are surrounded at both sides (in a circumferential direction) by the elastic material of the elastomer casing 32, or are embedded in said material. The elastomer casing 32 serves to hold the inner bushing 26 and the outer bushing 27 without impeding a defined relative movement of said components to a relevant extent. Specifically, the connecting portion 28 forms a pivot joint with a low pivoting moment, which permits pivoting of the outer bushing 27 relative to the inner bushing 26 about a pivot axis situated in the region of the connecting portion 28. During this pivoting movement, the projections 29, 30 of the inner bushing 26 and of the outer bushing 27 slide or roll on one another, whereas the elastomer casing 32 does not impede this relative movement of outer bushing 27 and inner bushing 26 to a relevant extent.

Provision is made for the bearing bushing 14 to be integrated into the housing 1 of the steering gear such that the pivoting of the helical pinion shaft 4 about the pivot axis 9 defined by the fixed bearing 8 leads to a displacement of the inner bushing 26 relative to the outer bushing 27 in a direction which is substantially perpendicular to the radial axis 35 leading through the connecting portion 28. By contrast, in the directions defined by said radial axis 35, as far as possible no displaceability of the inner bushing 26 relative to the outer bushing 27 should be possible, in order to avoid distortion of the helical pinion 3 on the toothed wheel 2 during the operation of the steering gear. This is achieved in that the spacing between the inner bushing 26 and the outer bushing 27 is, in that circumferential portion of the bearing bushing 14 which is situated radially opposite the connecting portion 28, restricted to a relatively small value of for example 0.1 mm. This is realized by means of a delimiting element 36 which is mounted, displaceably in a radial direction, within the outer bushing 27. The delimiting element 36 has a radial width which is greater than the radial width of the outer bushing 27, wherein the delimiting element 36 of the bearing bushing 14 that has not yet been installed in the housing 1 can be displaced outward to such an extent that it projects beyond the outer surface of the outer bushing 27. In this way, a relatively large spacing is set between the outer side of the inner bushing 26 and the delimiting element 36, which spacing permits relatively easy installation of the bearing bushing 14. Said spacing is reduced to the desired small dimension during the course of the installation of the floating bearing 7 in the housing 1, because then the delimiting element 36, owing to a collision with the housing 1, can no longer project beyond the outer surface of the outer bushing 27, and must consequently be displaced in the direction of the inner bushing 26.

The outer bushing 27 of the bearing bushing 14 furthermore also comprises an elastic stop element 37 which delimits a movement of the inner bushing 26 in one direction (upward in FIG. 1) during a pivoting of the helical pinion shaft 4.

Despite the spring-loading of the helical pinion shaft against the toothed wheel 2 by means of the fixed bearing 8 and despite the as far as possible small gearing play that can thereby be achieved, generation of noise during the operation of the steering gear cannot be entirely prevented. Such generation of noise is specifically additionally caused by operationally required relative movements of the components of the steering gear and in particular by the rolling of the balls of the ball bearings 11, 12 and by the cyclically changing engagement of the teeth of the helical pinion 3 and of the toothed wheel 2.

In order to achieve an as far as possible positive or low noise characteristic of the steering gear, and of the steering system that comprises said steering gear, during operation, provision is made according to the invention for a transmission of body-borne vibrations generated by said relative movements to the housing 1, which is composed for example of aluminum, to be minimized, whereby an excitation of vibrations caused by this, and thus sound radiation of the housing 1, can be kept at a low level.

For this purpose, provision is made firstly for the entire toothed wheel 2, or at least the teeth thereof, to be formed from or at least coated with plastic.

Provision is furthermore made for the bearing bushing 14 of the floating bearing 10 to be at least partially, in particular for the inner bushing 26 and/or the outer bushing 27 to be partially or entirely, formed from plastic.

As a further measure for preventing or minimizing an excitation of vibrations of the housing 1 owing to the rotational movements of the helical pinion shaft 4 and of the toothed wheel 2, provision is made for the outer ring 20 of the pivot ring 16 to be arranged fixedly, exclusively with the interposition of a multi-part, vibration-damping decoupling element 38, in the housing 1, wherein said decoupling element 38 is formed from plastic or an elastomer.

Finally, provision is made for the output shaft 7 of the steering motor 6, or an adapter piece 39, connected to a free end of said output shaft 7, to be connected with rotational driving action or rotationally conjointly, with the interposition of a clutch element which is likewise formed from plastic or an elastomer, to the helical pinion shaft 4 or to the thrust piece 22 which is connected rotationally conjointly by means of a toothing 41 to the adjoining end of the helical pinion shaft 4. A gap 42 between the adapter piece 39 and the thrust piece 22 prevents direct contact between these components, such that the connection with rotational driving action between the output shaft 7 of the steering motor 6 and the helical pinion shaft 4 is realized exclusively with the interposition of the clutch element 40.

By means of the measures according to the invention, all paths for the transmission of body-borne vibrations, which arise owing to the rotations of the helical pinion shaft 4 and of the toothed wheel 2, to the housing 1 are formed in at least one portion composed of vibration-damping plastic or elastomer, such that a resulting excitation of vibrations of the housing 1 and sound radiation, caused by this, of the housing 1 can be kept at a low level. Here, the best possible action with regard to the noise characteristics of the steering system can be achieved if all of these measures are implemented. It is however also possible for only some of these measures to be implemented, wherein a non-optimal action may then possibly be realized.

### LIST OF REFERENCE DESIGNATIONS

1 Housing
2 Toothed wheel
3 Helical pinion
4 Helical pinion shaft
5 Output shaft of the steering gear
6 Steering motor
7 Output shaft of the steering motor
8 Fixed bearing
9 Pivot axis
10 Floating bearing
11 Ball bearing of the fixed bearing
12 Ball bearing of the floating bearing
13 Bearing device of the fixed bearing
14 Bearing device/bearing bushing of the floating bearing
15 Bearing sleeve
16 Pivot ring
17 Inner ring of the pivot ring
18 Support disk
19 Outer bearing ring of the ball bearing of the fixed bearing
20 Outer ring of the pivot ring
21 Torsion web
22 Thrust piece
23 Screw
24 Screw ring
25 Longitudinal axis of the helical pinion shaft/of the ball bearing of the fixed bearing
26 Inner bushing of the bearing bushing
27 Outer bushing of the bearing bushing
28 Connecting portion of the bearing bushing
29 Projection of the inner bushing
30 Projection of the outer bushing
31 Annular gap between the inner bushing and the outer bushing
32 Elastomer casing of the bearing bushing
33 Depression of the outer bushing
34 Depression of the inner bushing
35 Radial axis through the connecting portion of the bearing bushing
36 Delimiting element
37 Stop element
38 Decoupling element
39 Adapter piece
40 Coupling element
41 Toothing
42 Gap

1. A steering system for a motor vehicle, comprising:
a steering gear, including:
a housing;
a toothed wheel;
a fixed bearing, having:
a bearing sleeve
a rotary bearing received in the bearing sleeve; and
a pivot ring that includes:
one or more torsion webs;
an outer ring fixed in the housing; and
an inner ring connected to or integrated into the bearing sleeve, the inner ring and the outer ring pivotably connected to each other via the one or more torsion webs
a floating bearing, having:
a bearing bushing mounted in the housing; and
a rotary bearing received in the bearing bushing so as to be radially mobile within the housing, and
a helical pinion shaft, having:
a first portion received in the rotary bearing so as to be mounted in the fixed bearing;
a second portion received in the rotary bearing of the floating bearing so as to be mounted in the floating bearing; and
a helical pinion that meshes with the toothed wheel, and that is located between the first portion and the second portion;
a clutch element; and
a steering motor connected, exclusively via the clutch element, with rotational driving action, to the helical pinion shaft of the steering gear,
wherein at least one of:
(i) one or more of the outer ring of the pivot ring of the fixed bearing and the bearing bushing of the floating bearing fixed in the housing via interposition of a vibration-damping decoupling element, and
(ii) at least one of the pivot ring of the fixed bearing, the bearing bushing of the floating bearing, the helical pinion, the toothed wheel and the clutch element is formed at least partially from a vibration-damping material.

2. The steering system as claimed in claim 1, wherein:
the bearing bushing of the floating bearing has:
an inner bushing that receives the rotary bearing of the floating bearing; and
an outer bushing that surrounds the inner bushing and that is fixed in the housing;
the outer bushing and the inner bushing delimit an annular gap; and
the outer bushing and the inner bushing are connected to on via a flexible connecting portion such that the outer bushing and the inner bushing are movable relative to each other in at least one radial direction.

3. The steering system as claimed in claim 1, wherein the vibration-damping material is a plastic or an elastomer.
